(19) United States
(12) Patent Application Publication
(10) Pub. No.: US 2026/0311550 A1
(43) Pub. Date: Oct. 8, 2026

(54) BACCARAT GAME SYSTEM WITH RANDOM ODDS

(71) Applicant: JUMBO TECHNOLOGY CO., LTD., TAICHUNG (TW)

(72) Inventors: Shun Tsung HSU, TAICHUNG (TW); Chang Yi WANG, TAICHUNG (TW)

(21) Appl. No.: 19/711,307

(22) Filed: Jun. 17, 2026

Related U.S. Application Data
(63) Continuation-in-part of application No. 19/193,645, filed on Apr. 29, 2025.
Application No. 19/193,645 is a continuation of application No. 19/072,196, filed on Mar. 6, 2025, now abandoned.
Application No. 19/072,196 is a continuation-in-part of application No. 17/915,980, filed on Apr. 1, 2020, now Pat. No. 12,249,214.
Application No. 19/072,196 is a continuation-in-part of application No. 18/251,793, filed on Dec. 3, 2020.
(60) Provisional application No. 63/960,151, filed on Jan. 14, 2026.
(60) Provisional application No. 64/002,379, filed on Mar. 11, 2026.

(51) Int. Cl. G07F 17/32; G06T 7/70

(52) U.S. Cl. CPC G07F 17/323; G06T 7/70; G07F 17/3209; G07F 17/3211

(57) ABSTRACT

The present application provides a baccarat game system with random odds. The baccarat game system includes a game processing unit, a user interface unit, a betting unit, an odds processing unit, a game result generating unit, and a payout unit. The odds processing unit generates a random odds table having a plurality of payout odds. Among the plurality of payout odds, when a betting option and a game result associated with a payout odd do not correspond to each other, the odds processing unit assigns a value of 0 to the payout odd. For each remaining payout odd, the odds processing unit generates one of a plurality of odds values correspondingly for that one of the plurality of payout odds, and selects one of the plurality of odds values as the payout odd.

### CROSS-REFERENCE TO RELATED APPLICATIONS

This application claims priority to U.S. Provisional Patent Application Ser. No. 63/960,151, filed Jan. 14, 2026, entitled “BACCARAT GAME SYSTEM WITH RANDOM ODDS”; U.S. Provisional Patent Application Ser. No. 64/002,379, filed Mar. 11, 2026, entitled “BACCARAT GAME SYSTEM WITH RANDOM ODDS”; and U.S. patent application Ser. No. 19/193,645, filed Apr. 29, 2025, entitled “GAME SYSTEM AND METHOD FOR PROVIDING VARIABLE ODDS WITH IMAGE SYNTHESIS DISPLAY.”

U.S. patent application Ser. No. 19/193,645 is a continuation-in-part of U.S. patent application Ser. No. 19/072,196, filed Mar. 6, 2025, entitled “GAME SYSTEM FOR PROVIDING VARIABLE ODDS WITH IMAGE SYNTHESIS DISPLAY”, which is a continuation-in-part of U.S. patent application Ser. No. 17/915,980, filed Apr. 1, 2020, entitled “GAMBLING GAME SYSTEM AND METHOD FOR PROVIDING VARIABLE ODDS,” and U.S. patent application Ser. No. 18/251,793, filed Dec. 3, 2020, entitled “GAME SYSTEM HAVING IMAGE COMPOSITING DISPLAY.”

Each of these priority applications is incorporated by reference herein in its entirety.

### TECHNICAL FIELD

The present application relates to a baccarat game system, and more particularly to a baccarat game system with random odds.

### BACKGROUND

Baccarat has simple game rules and a high Return to Player (RTP) rate, and is therefore a popular game. The baccarat game has three game results, namely “banker win”, “player win”, and “tie”, and a plurality of betting options respectively corresponding to the three game results. For example, a player may bet on three betting options including “banker win”, “player win”, and “tie”. Alternatively, in other known manners of play, the player may also bet on other betting options, such as “banker win” with a natural, “player win” with a natural, and the like.

The baccarat game is a card-based game. A dealer deals two cards to each of a banker and a player, and determines whether an additional card is to be drawn according to card values based on a drawing rule. When no additional card is to be drawn, or after drawing of the additional card is completed, total card values of the banker and the player are compared to determine whether the game result is “player win”, “tie”, or “banker win”. The drawing rule is a rule set for the baccarat game. Unless otherwise specified, the drawing rule follows a conventional card-drawing procedure, and details thereof are omitted herein.

In the baccarat game, according to the existing drawing rule, probabilities of the game results being “banker win”, “player win”, and “tie” are approximately 45.8%, 44.6%, and 9.5%, respectively. The corresponding odds, with the commission, are usually 0.95 to 1 (with a 5% commission charged to the banker), 1 to 1, and 8 to 1. Alternatively, the corresponding odds, without the commission, may be 1 to 1, 1 to 1, and 8 to 1, except that odds for the banker winning with six points are 0.5 to 1. When the game result is a “tie” and the betting option is “banker win” or “player win”, the bet is returned. Therefore, the RTP rates of the three betting options including “banker win”, “player win”, and “tie” are approximately 98.94%, 98.76%, and 85.64%, respectively.

In the baccarat game, since the RTP rates of the betting options of “banker win” and “player win” are higher than 98%, the operating profit of an operator may be adversely affected. In addition, the odds for the betting options of “banker win” and “player win” are fixed at 0.95 to 1 and 1 to 1, respectively, so that the volatility of the game is relatively low. As a result, players' expectations for high odds may not be satisfied.

### BRIEF SUMMARY

A main objective of the present application is to provide a baccarat game system with random odds. Without changing the core gameplay, including the three betting options of “banker win”, “player win”, and “tie”, the baccarat game system allows “banker win”, “player win”, or “tie” to have an opportunity to obtain high-value odds, thereby satisfying a player's expectation for high odds.

To achieve the above objective, the present application provides a baccarat game system with random odds. The baccarat game system provides a baccarat game for at least one game round. The baccarat game has a plurality of game results and a standard odds table. Each of the game results has a probability of occurrence in the at least one game round, and the standard odds table is assigned a plurality of standard odds.

The baccarat game system includes a game processing unit, a user interface unit, a betting unit, an odds processing unit, a game result generating unit, and a payout unit. The user interface unit is connected to the game processing unit, and displays a game screen and a plurality of betting areas for the at least one game round. The plurality of betting areas respectively correspond to a plurality of betting options, so as to allow at least one player to bet on at least one of the plurality of betting options. The betting unit is connected to the game processing unit, and receives a bet on the plurality of betting areas in the at least one game round to generate betting data.

The odds processing unit is connected to the game processing unit, and is controlled by the game processing unit to generate a random odds table. The random odds table has a plurality of payout odds. The plurality of payout odds are respectively associated with one of the game results and one of the betting options. When any of the betting options and any of the game results, which are associated with one of the plurality of payout odds, do not correspond to each other, that one of the payout odds is assigned a value of 0 by the odds processing unit. When any of the betting options and any of the game results, which are associated with one of the plurality of payout odds, do correspond to each other, the odds processing unit generates one of a plurality of odds values correspondingly for that one of the payout odds. Each of the plurality of payout odds and the corresponding one of the plurality of standard odds are associated with the same one of the betting options and the same one of the game results.

The plurality of odds values corresponding to each of the payout odds respectively have probabilities to be selected. The odds processing unit selects according to the probabilities to be selected of the plurality of odds values, so that the plurality of odds values corresponding to each of the payout odds are assigned to each of the payout odds in a many-to-one manner. A portion of the plurality of odds values are lower than values of the corresponding ones of the standard odds.

The game result generating unit is connected to the game processing unit, and randomly generates one of the plurality of game results in the at least one game round. The payout unit is connected to the game processing unit, and pays out according to each of the game results generated in the at least one game round, the betting data, and the random odds table.

In another embodiment, the plurality of odds values are greater than or equal to values of the corresponding ones of the plurality of standard odds, and the payout unit selects one of the random odds table and the standard odds table to pay out.

### BRIEF DESCRIPTION OF FIGURES

FIG. 1 is an exemplary system architecture diagram of the present application.

FIG. 2 is an exemplary schematic view of a gaming machine implementing the present application.

FIG. 3 is an exemplary game screen of the present application.

FIGS. 4, 5, and 6 are exemplary views of payout odds according to a first embodiment of the present application.

FIG. 7 is an operation flow chart according to the first embodiment of the present application.

FIGS. 8 and 9 are exemplary views of payout odds according to a second embodiment of the present application.

FIG. 10 is an operation flow chart according to the second embodiment of the present application.

FIGS. 11A to 11D are exemplary game screens according to a third embodiment of the present application.

FIG. 12 is an operation flow chart according to the third embodiment of the present application.

FIG. 13 is another exemplary game screen according to the third embodiment of the present application.

### DETAILED DESCRIPTION

The following provides a detailed description of the present application and the technical features thereof with reference to the accompanying drawings, but the embodiments are merely illustrative and should not be construed as limiting the scope of the present application.

The present application is a baccarat game system with random odds, which provides a baccarat game for at least one game round. The baccarat game has a plurality of game results, a plurality of betting options, and a standard odds table. In one embodiment, the baccarat game has three game results, namely “player win”, “tie”, and “banker win”. The plurality of betting options correspond to the three game results. The three game results respectively have a probability of occurrence in the at least one game round. The standard odds table is assigned a plurality of standard odds. The plurality of standard odds are respectively associated with one of the plurality of betting options and one of the three game results. In the embodiments described below, the plurality of game results are exemplified by “player win”, “tie”, and “banker win”, but are not limited thereto.

In one embodiment, the plurality of betting options include three options of “betting on player”, “betting on tie”, and “betting on banker”, which directly correspond to the three game results of “player win”, “tie”, and “banker win”, but are not limited thereto. In other embodiments, the betting options further include player pair, banker pair, or the like, which are subcategories of the three game results. More specifically, the betting options of player pair or banker pair respectively correspond to game results in which the first two cards of the player or the banker have the same card value, regardless of whether the game result is “player win”, “tie”, or “banker win”.

In a conventional baccarat game, the standard odds associated with the game result being “tie” and the betting option being “betting on player” or “betting on banker” are assigned a value of 1 time. In the present application, the standard odds associated with the game result being “tie” and the betting option being “betting on player” or “betting on banker” are assigned a value of 0. Values assigned to the other standard odds are shown in Table 1.

TABLE 1

game result

| betting option | player win | tie | banker win |
|---|---|---|---|
| betting on player | 2 times | 0 | 0 |
| betting on tie | 0 | 9 times | 0 |
| betting on banker | 0 | 0 | 1.95 times |

According to Table 1, when the baccarat game is played with the standard odds, if the betting option selected by the at least one player is “betting on player” and a bet amount is 1 unit, the player obtains a payout of 2 units (including the returned bet amount) when the game result is “player win”, and the player obtains 0 units when the game result is “tie” or “banker win”.

If the betting option selected by the at least one player is “betting on tie” and a bet amount is 1 unit, the player obtains a payout of 9 units (including the returned bet amount) when the game result is “tie”, and the player obtains 0 units when the game result is “player win” or “banker win”.

If the betting option selected by the at least one player is “betting on banker” and a bet amount is 1 unit, the player obtains a payout of 1.95 units (including the returned bet amount) when the game result is “banker win”, and the player obtains 0 units when the game result is “player win” or “tie”.

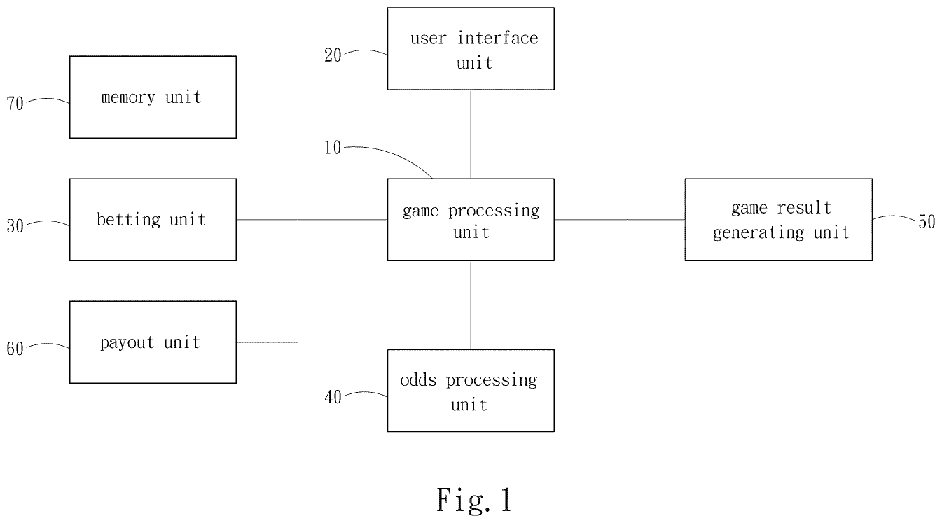

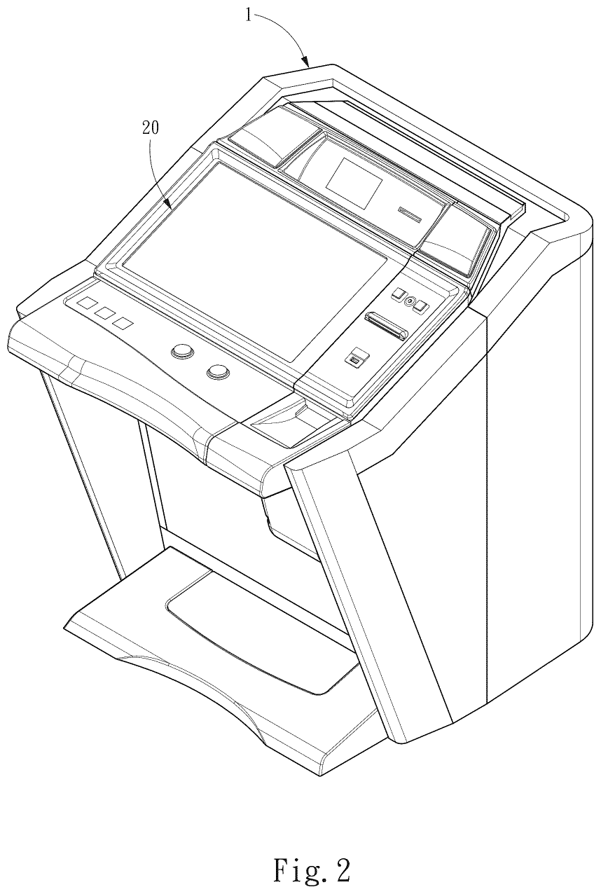

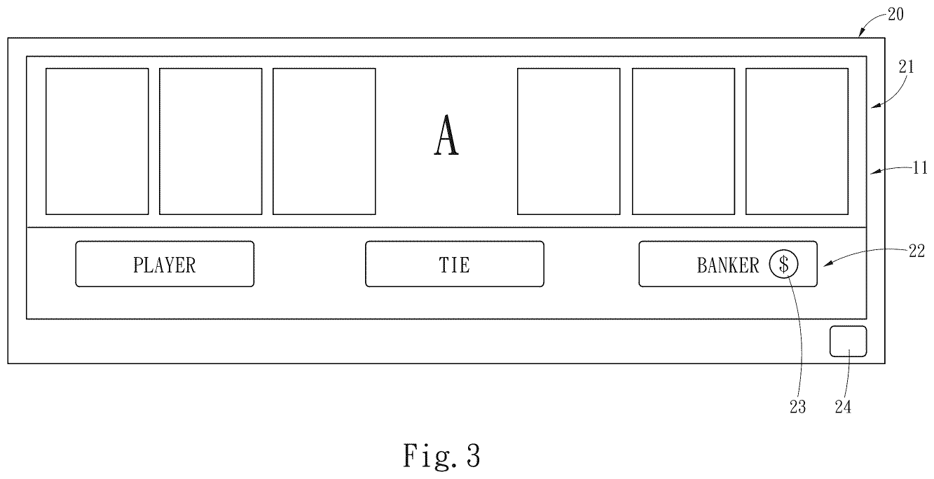

Referring to FIG. 1, FIG. 2, and FIG. 3, a first embodiment of the present application is shown. The baccarat game system includes a game processing unit 10, a user interface unit 20, a betting unit 30, an odds processing unit 40, a game result generating unit 50, and a payout unit 60.

The game processing unit 10 controls operation of the baccarat game. More specifically, the game processing unit 10 is connected to the user interface unit 20, the betting unit 30, the odds processing unit 40, the game result generating unit 50, and the payout unit 60. The game processing unit 10 operates together with the units, and transmits instructions, data, and the like required for operation of the units, thereby controlling operation of the baccarat game.

The user interface unit 20 displays a game screen 21 for the at least one game round and a plurality of betting areas 22. The plurality of betting areas 22 respectively correspond to the plurality of betting options, so as to allow at least one player to bet on at least one of the plurality of betting options. As shown in FIG. 3, in one embodiment, the plurality of betting areas 22 include three betting areas, which are respectively labeled as PLAYER, TIE, and BANKER from left to right, and correspond to the plurality of betting options of “betting on player”, “betting on tie”, and “betting on banker”, respectively.

In one embodiment, the user interface unit 20 is a touch screen and is configured on a gaming machine 1. In other embodiments, the user interface unit 20 may also be configured on a remote personal information device, such as a personal computer, a notebook computer, a smart phone, or a tablet, but is not limited thereto.

The betting unit 30 receives a signal corresponding to a bet 23 placed on the plurality of betting areas 22 in the at least one game round to generate betting data. The betting data includes a bet amount of the bet 23 and position information indicating which one of the plurality of betting areas 22 the bet 23 is located on. In one embodiment, the placement of the bet 23 is completed when the at least one player places chips of a specific amount on the plurality of betting areas 22. At this time, the betting unit 30 generates the betting data including the bet amount of the bet 23 and position information indicating where the bet 23 is located on the plurality of betting areas 22.

In other embodiments, the at least one player may also press a confirmation button 24 to confirm the placement of the bet 23 is completed, and the betting unit 30 generates the betting data only after such confirmation is made. As shown in FIG. 3, the at least one player places chips on one of the plurality of betting areas 22 labeled BANKER, and may further press the confirmation button 24 to confirm that the bet 23 is placed on the betting area 22 labeled BANKER. It is worth noting that the actions of placing or pressing described above are not limited to being performed with the user interface unit 20 configured on the gaming machine 1 or configured on a remote device, and are not limited to tapping a touch screen or selecting with a button, a mouse, or another manner.

The odds processing unit 40 is controlled by the game processing unit 10 to generate a random odds table. In one embodiment, after the betting unit 30 stops receiving the signal corresponding to the bet 23, the game processing unit 10 controls the odds processing unit 40 to generate the random odds table. The random odds table has a plurality of payout odds. The plurality of payout odds are respectively associated with one of the three game results of “banker win”, “player win”, and “tie”, and one of the three betting options of “betting on banker”, “betting on player”, and “betting on tie”.

When any of the betting options and any of the game results, which are associated with one of the plurality of payout odds, do not correspond to each other, that one of the payout odds is assigned a value of 0 by the odds processing unit 40. When any of the betting options and any of the game results, which are associated with one of the plurality of payout odds, do correspond to each other, the odds processing unit 40 generates one of a plurality of odds values correspondingly for that one of the payout odds. In one embodiment, whether each of the betting options corresponds to each of the game results is determined according to a win-loss relationship between the banker and the player.

For example, when the betting option is “betting on player”, if the game result is “player win”, the betting option and the game result correspond to each other. If the game result is “banker win” or “tie”, the betting option and the game result do not correspond to each other. When the betting option is “betting on tie”, if the game result is “tie”, the betting option and the game result correspond to each other. If the game result is “banker win” or “player win”, the betting option and the game result do not correspond to each other. When the betting option is “betting on banker”, if the game result is “banker win”, the betting option and the game result correspond to each other. If the game result is “player win” or “tie”, the betting option and the game result do not correspond to each other.

Each of the plurality of payout odds and the corresponding one of the standard odds are associated with the same one of the betting options and the same one of the game results, and the plurality of odds values corresponding to each of the payout odds respectively have probabilities to be selected.

As shown in Table 1, when the betting option associated with the payout odds is “betting on player”, the corresponding standard odds are 2 times. When the betting option associated with the payout odds is “betting on tie”, the corresponding standard odds are 9 times. When the betting option associated with the payout odds is “betting on banker”, the corresponding standard odds are 1.95 times.

In one embodiment, each of the payout odds is set for one betting option and one game result corresponding to the betting option. When the betting option corresponding to each of the payout odds is “betting on player”, “betting on tie”, and “betting on banker”, the corresponding standard odds are 1 to 1, 8 to 1, and 0.95 to 1, respectively. These values do not include a bet amount that needs to be returned. For example, when the betting option is “betting on banker” and the bet amount is 1 unit, the value of the standard odds is 0.95 to 1. When the bet wins, a payout of (1+0.95) units, including the returned bet amount of 1 unit, is obtained.

The odds processing unit 40 is configured to select one of the plurality of odds values as each of the payout odds according to the probabilities to be selected of the plurality of odds values, so that the plurality of odds values are assigned to each of the payout odds in a many-to-one manner. A portion of the plurality of odds values are lower than the values of corresponding ones of the standard odds. A total of the probabilities to be selected of the plurality of odds values corresponding to each of the payout odds is 100%. Each of the payout odds assigned by the odds processing unit 40 respectively has an expected value. Each expected value is a weighted average of odds values expected to be obtained. The expected value is calculated according to the plurality of odds values corresponding to each of the payout odds and with reference to the probabilities to be selected of the plurality of odds values. Detailed calculation is described below. Furthermore, each of the standard odds has a fixed value, and therefore an expected value of each of the standard odds is the fixed value.

In one embodiment, a difference between the expected value of each of the payout odds assigned by the odds processing unit 40 and the expected value of the corresponding standard odds is a first variation value. The plurality of odds values satisfy a requirement that the first variation value is minimized. In other words, the odds processing unit 40 assigns the plurality of odds values and the probabilities to be selected thereof in a manner of minimizing the first variation value.

In one embodiment, the standard odds corresponding to “betting on banker” are 1.95 times. The plurality of odds values generated by the odds processing unit 40 and the probabilities to be selected corresponding to the plurality of odds values are shown in Table 2.

TABLE 2

| odds value | 1.5 times | 2.5 times | 4 times | 5 times |
|---|---|---|---|---|
| probability to be | 79% | 9% | 6% | 6% |
| selected | | | | |

When one odds value is selected according to the probability to be selected and is assigned to the payout odds in a many-to-one manner, the expected value of the payout odds is a sum of products of the odds values (1.5 times, 2.5 times, 4 times, and 5 times) and the corresponding probabilities to be selected (79%, 9%, 6%, and 6%), and is calculated as 1.95 times (i.e., calculated from 1.5*79%+2.5*9%+4*6%+5*6%). Compared with the corresponding standard odds of 1.95 times, the first variation value is 0, and the requirement that the first variation value is minimized is therefore satisfied.

In one embodiment, the standard odds corresponding to “betting on player” are 2 times. The plurality of odds values generated by the odds processing unit 40 and the probabilities to be selected corresponding to the plurality of odds values are shown in Table 3.

TABLE 3

| odds value | 1.5 times | 2.5 times | 4 times | 5 times |
|---|---|---|---|---|
| probability to be | 75.5% | 11.5% | 7% | 6% |
| selected | | | | |

When one odds value is selected according to the probability to be selected and is assigned to the payout odds in a many-to-one manner, the expected value of the payout odds is calculated as 2 times (i.e., calculated from 1.5*75.5%+2.5*11.5%+4*7%+5*6%). Compared with the corresponding standard odds of 2 times, the first variation value is 0, and the requirement that the first variation value is minimized is also satisfied.

In one embodiment, the standard odds corresponding to “betting on tie” are 9 times. The plurality of odds values generated by the odds processing unit 40 and the probabilities to be selected corresponding to the plurality of odds values are shown in Table 4.

TABLE 4

| odds value | 6 times | 11 times | 13 times | 15 times |
|---|---|---|---|---|
| probability to be | 48.8% | 36.2% | 8% | 7% |
| selected | | | | |

When one odds value is selected according to the probability to be selected and is assigned to the payout odds in a many-to-one manner, the expected value of the payout odds is calculated as 9 times (i.e., calculated from 6*48.8%+11*36.2%+13*8%+15*7%). Compared with the corresponding standard odds of 9 times, the first variation value is 0, and the requirement that the first variation value is minimized is also satisfied.

When the payout odds are assigned odds values by the odds processing unit 40, the odds values are respectively selected and assigned according to the odds values recorded in Table 2, Table 3, and Table 4 and the corresponding probabilities to be selected.

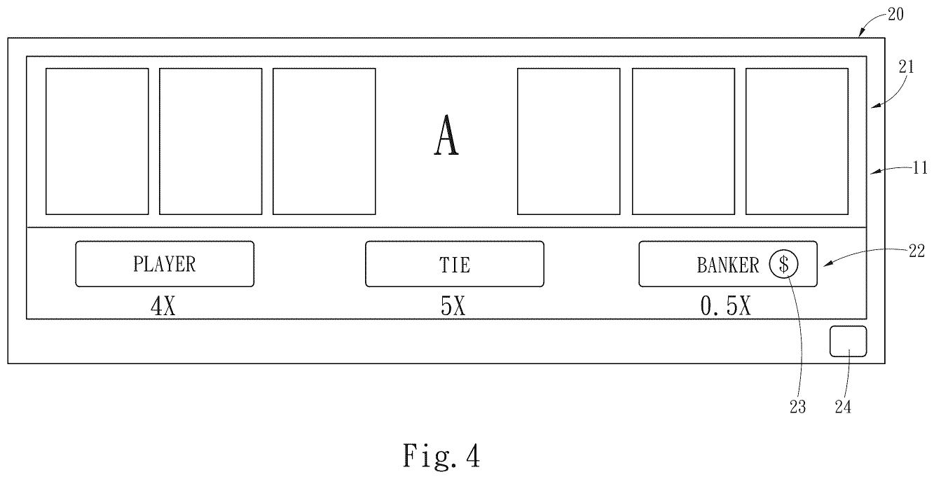

Referring to FIG. 4, in one embodiment, the generated random odds table is shown in Table 5.

TABLE 5

| | game result | | |
|---|---|---|---|
| betting option | player win | tie | banker win |
| betting on player | 5 times (4X) | 0 | 0 |
| betting on tie | 0 | 6 times (5X) | 0 |
| betting on banker | 0 | 0 | 1.5 times (0.5X) |

It is particularly noted that the value of each of the payout odds labeled on each of the plurality of betting areas 22 in FIG. 4 is indicated only as winning odds, and is marked with “X”. The value does not include a bet amount to be returned, so that the indication better conforms to the playing habit of the at least one player in the baccarat game. Each of the payout odds labeled on each of the plurality of betting areas 22 in the drawings of the present application is processed in the same manner.

As shown in Table 5, the payout odds for “player win” and “betting on player” are assigned as 5 times by the odds processing unit 40 (labeled as 4× in the drawing); the payout odds for “tie” and “betting on tie” are assigned as 6 times by the odds processing unit 40 (labeled as 5× in the drawing); and the payout odds for “banker win” and “betting on banker” are assigned as 1.5 times by the odds processing unit 40 (labeled as 0.5× in the drawing).

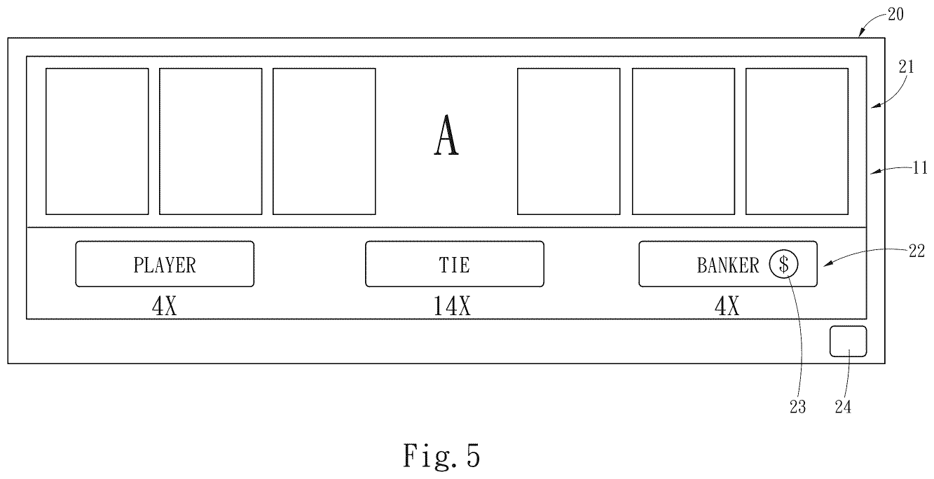

Referring to FIG. 5, in one embodiment, the generated random odds table is shown in Table 6.

TABLE 6

| | game result | | |
|---|---|---|---|
| betting option | player win | tie | banker win |
| betting on player | 5 times (4X) | 0 | 0 |
| betting on tie | 0 | 15 times (14X) | 0 |
| betting on banker | 0 | 0 | 5 times (4X) |

The payout odds for “player win” and “betting on player” are assigned as 5 times by the odds processing unit 40 (labeled as 4× in the drawing); the payout odds for “tie” and “betting on tie” are assigned as 15 times by the odds processing unit 40 (labeled as 14× in the drawing); and the payout odds for “banker win” and “betting on banker” are assigned as 5 times by the odds processing unit 40 (labeled as 4× in the drawing).

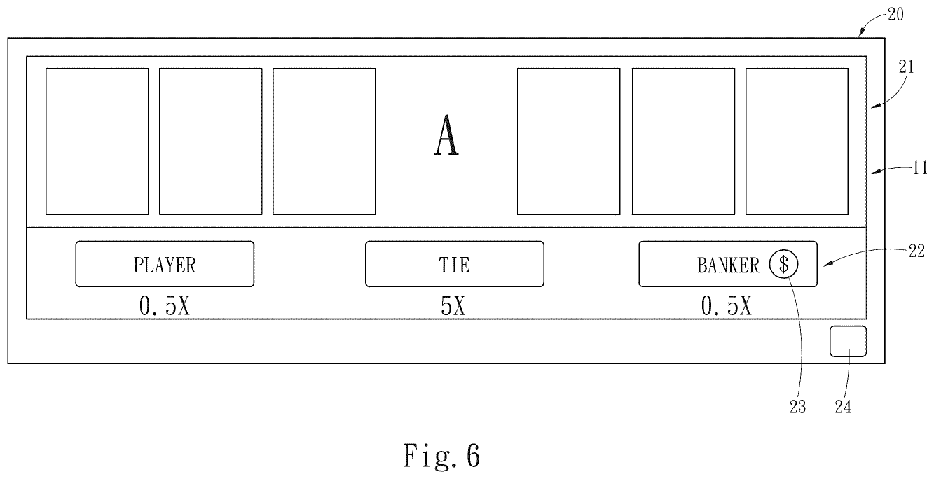

Referring to FIG. 6, in one embodiment, the generated random odds table is shown in Table 7.

TABLE 7

| | game result | | |
|---|---|---|---|
| betting option | player win | tie | banker win |
| betting on player | 1.5 times (0.5X) | 0 | 0 |
| betting on tie | 0 | 6 times (5X) | 0 |
| betting on banker | 0 | 0 | 1.5 times (0.5X) |

The payout odds for “player win” and “betting on player” are assigned as 1.5 times by the odds processing unit 40 (labeled as 0.5× in the drawing); the payout odds for “tie” and “betting on tie” are assigned as 6 times by the odds processing unit 40 (labeled as 5× in the drawing); and the payout odds for “banker win” and “betting on banker” are assigned as 1.5 times by the odds processing unit 40 (labeled as 0.5× in the drawing).

In one embodiment, a difference between an RTP rate of the baccarat game calculated from expected values of the payout odds assigned by the odds processing unit 40 and that calculated from corresponding ones of the standard odds is a second variation value. The plurality of odds values satisfy a requirement that the second variation value is minimized. In other words, the odds processing unit 40 assigns the plurality of odds values and the probabilities to be selected thereof in a manner of minimizing the second variation value.

More specifically, the standard odds can be used to calculate an original RTP rate of the baccarat game. After the odds processing unit 40 generates the plurality of odds values and the probabilities to be selected thereof for each of the payout odds, the expected value of each of the payout odds can be calculated. After the expected values of the payout odds are obtained, a changed RTP rate of the baccarat game can be calculated. Accordingly, a difference between the original RTP rate and the changed RTP rate is the second variation value. When the odds processing unit 40 assigns the plurality of odds values and the probabilities to be selected thereof for each of the payout odds in a manner of minimizing the second variation value, the RTP rate of the baccarat game may remain unchanged.

In this embodiment, because the changed RTP rate is calculated after the expected values of the payout odds for “betting on player”, “betting on tie”, and “betting on banker” are considered as a whole, the values assigned to the payout odds by the odds processing unit 40 may be considered in a complementary manner, and therefore more variation is provided.

For example, the expected value of the payout odds for “betting on player” or “betting on tie” may be lower than the corresponding standard odds. Accordingly, the expected value of the payout odds for “betting on banker” may be higher than the corresponding standard odds, which means that the values assigned to the payout odds for “betting on banker” by the odds processing unit 40 may be significantly increased.

In one embodiment, the odds processing unit 40 first determines at least one of an upper limit, a lower limit, and a quantity of the plurality of odds values, so that the odds processing unit 40 generates the plurality of odds values according thereto. More specifically, the odds processing unit 40 first determines at least one of the upper limit, the lower limit, and the quantity of the plurality of odds values according to a preset value of the game processing unit 10, an input by the player, or another manner, but is not limited thereto. This helps simplify calculation complexity of generating the plurality of odds values by the odds processing unit 40.

The upper limit and the lower limit of the plurality of odds values are respectively the highest value and the lowest value that may appear among the plurality of odds values. The quantity of the plurality of odds values is the number of possible values of the plurality of odds values. In one embodiment, the upper limit of the plurality of odds values is not more than five times the original odds value, the lower limit is not less than 40% of the original odds value, and the quantity is two to four, but the present application is not limited thereto.

In one embodiment, the baccarat game system of the present application further includes a memory unit 70. The memory unit 70 stores a plurality of value tables. The plurality of value tables respectively records different sets of the plurality of odds values. The plurality of value tables stored in the memory unit 70 may be generated in advance in a random manner or may be input and stored in the memory unit 70. The plurality of odds values recorded in the plurality of value tables satisfy the requirement that the first variation value is minimized. Alternatively, the plurality of odds values recorded in the plurality of value tables satisfy the requirement that the second variation value is minimized. This helps avoid complicated and difficult calculation.

When the payout odds are assigned by the odds processing unit 40, after the game processing unit 10 receives an activation signal, the game processing unit 10 activates one of the plurality of value tables. The activation signal may be generated by input with the user interface unit 20, or may be a preset value set in advance for activating one of the plurality of value tables. In other words, the value table to be used for playing the game may be selected and activated by the player. The game processing unit 10 controls the odds processing unit 40 to assign the plurality of odds values recorded in any of the value tables that are activated to each of the payout odds in a many-to-one manner. A portion of the plurality of odds values recorded in each of the value tables are lower than the values of corresponding ones of the standard odds.

The game result generating unit 50 randomly generates one of the three game results in the at least one game round according to the probability of occurrence. In one embodiment, the game result generating unit 50 may use physical playing cards or virtual playing cards. When physical playing cards are used, live streaming may be incorporated to increase credibility of the game result generating unit 50. In one embodiment, the live streaming is performed by capturing, with a camera device in a continuous real-time broadcast manner, a process in which the game result generating unit 50 generates the game result, thereby generating a broadcast image. The broadcast image is transmitted to the user interface unit 20 in real time, so that the player can watch the broadcast image in real time. Because the broadcast image is not edited and is transmitted in real time, the player can believe that falsification is not possible, thereby increasing credibility of the game result generating unit 50.

The payout unit 60 pays out according to each of the game results generated in the at least one game round, the betting data, and the random odds table.

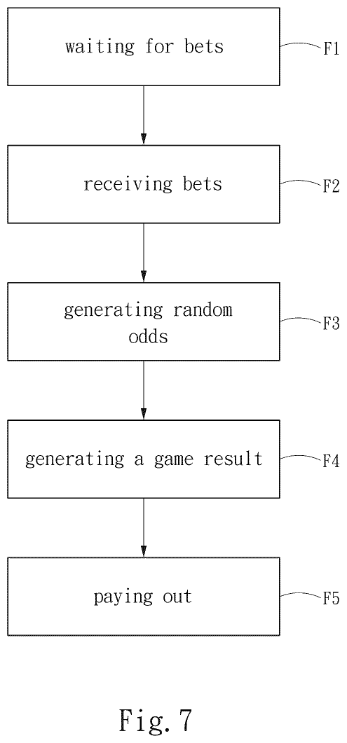

Referring to FIG. 7, FIG. 7 is an operation flow chart according to the first embodiment of the present application. The flow steps shown in the drawing are merely examples and are not limited thereto. In one embodiment, the game processing unit 10 performs steps F1 to F5.

Step F1: waiting for bets. The game processing unit 10 controls the user interface unit 20 to provide the plurality of betting options with the plurality of betting areas 22, so that the player bets on the plurality of betting options within a betting time.

Step F2: receiving bets. The game processing unit 10 controls the betting unit 30 to receive the signal corresponding to the bet 23 on the plurality of betting areas 22 to generate the betting data.

Step F3: generating random odds. The game processing unit 10 controls the odds processing unit 40 to generate the random odds table.

Step F4: generating a game result. The game processing unit 10 controls the game result generating unit 50 to randomly generate one of the game results according to the probability of occurrence. It is particularly noted that the order of step F3 and step F4 may be changed according to requirements, and is not limited to the above order.

Step F5: paying out. The game processing unit 10 controls the payout unit 60 to pay out according to each of the game results generated in the at least one game round, the betting data, and the random odds table.

More specifically, each of the game results may be generated by the game processing unit 10. The betting data may be generated by the player betting on the betting options (“betting on player”, “betting on tie”, and “betting on banker”). The betting data includes the bet amount of the bet 23 and the position information indicating which one of the plurality of betting areas 22 (betting options) the bet 23 is located on. After the payout unit 60 obtains the game results and the betting data, the payout unit 60 pays out according to the random odds table. For example, payout may be performed according to the random odds tables shown in Table 5, Table 6, or Table 7.

As described above, in the first embodiment, the odds processing unit 40 assigns the plurality of odds values and the probabilities to be selected thereof to the payout odds in a manner of minimizing the first variation value or the second variation value.

In one embodiment, an odds value lower than the corresponding standard odds is usually assigned a higher probability to be selected, so that the plurality of odds values can be assigned relatively large values (for example, 5 times or 15 times). Consequently, the odds value lower than the corresponding standard odds appears more frequently. For example, as shown in FIG. 6, the player may easily see, on the game screen 21, that many or all of the odds values are lower than the corresponding standard odds. When similar game results randomly occur many times consecutively within a short time, although the game results are randomly generated, such a situation may easily reduce the player's interest in playing the game.

The present application also discloses a second embodiment, which helps avoid a situation in which many or all of the payout odds are assigned low odds values by the odds processing unit 40.

The technical features of the second embodiment of the present application are substantially the same as those of the first embodiment, and differences are described below.

In the second embodiment, the plurality of odds values may be set to be greater than or equal to values of corresponding ones of the plurality of standard odds. Accordingly, after the odds processing unit 40 assigns one of the plurality of odds values to each of the payout odds, each of the odds values is only greater than or equal to the corresponding standard odds.

In the second embodiment, similarly, a difference between the expected value of each of the payout odds assigned by the odds processing unit 40 and the expected value of the corresponding standard odds is the first variation value. Preferably, the odds processing unit 40 assigns the plurality of odds values and the probabilities to be selected thereof in a manner of increasing the first variation value by a first designated value.

In one embodiment, the standard odds corresponding to “betting on banker” are 1.95 times, the first designated value is assigned as 0.35 times by the odds processing unit 40, and the plurality of odds values generated by the odds processing unit 40 and the probabilities to be selected corresponding to the plurality of odds values are shown in Table 8.

TABLE 8

| odds value | 1.95 times | 2.5 times | 4 times | 5 times |
|---|---|---|---|---|
| probability to be | 80% | 8% | 6% | 6% |
| selected | | | | |

When one odds value is selected according to the probability to be selected and is assigned to the payout odds in a many-to-one manner, the expected value of the payout odds may be calculated as 2.3 times (i.e., calculated from 1.95*80%+2.5*8%+4*6%+5*6%). Compared with the corresponding standard odds of 1.95 times, the first variation value is 0.35 times, and the requirement that the first variation value increases by the first designated value is therefore satisfied.

In one embodiment, the standard odds corresponding to “betting on player” are 2 times, the first designated value is assigned as 0.34 times by the odds processing unit 40, and the plurality of odds values generated by the odds processing unit 40 and the probabilities to be selected corresponding to the plurality of odds values are shown in Table 9.

TABLE 9

| odds value | 2 times | 2.5 times | 4 times | 5 times |
|---|---|---|---|---|
| probability to be | 80% | 8% | 6% | 6% |
| selected | | | | |

When one odds value is selected according to the probability to be selected and is assigned to the payout odds in a many-to-one manner, the expected value of the payout odds may be calculated as 2.34 times (i.e., calculated from 2*80%+2.5*8%+4*6%+5*6%). Compared with the corresponding standard odds of 2 times, the first variation value is 0.34 times, and the requirement that the first variation value increases by the first designated value is therefore satisfied.

In one embodiment, the standard odds corresponding to “betting on tie” are 9 times, the first designated value is assigned as 1.24 times by the odds processing unit 40, and the plurality of odds values generated by the odds processing unit 40 and the probabilities to be selected corresponding to the plurality of odds values are shown in Table 10.

TABLE 10

| odds value | 9 times | 11 times | 13 times | 15 times |
|---|---|---|---|---|
| probability to be | 60% | 25% | 8% | 7% |
| selected | | | | |

When one odds value is selected according to the probability to be selected and is assigned to the payout odds in a many-to-one manner, the expected value of the payout odds may be calculated as 10.24 times (i.e., calculated from 9*60%+11*25%+13*8%+15*7%). Compared with the corresponding standard odds of 9 times, the first variation value is 1.24 times, and the requirement that the first variation value increases by the first designated value is therefore satisfied.

In the second embodiment, similarly, according to the manner described in the first embodiment, a difference between an RTP rate of the baccarat game calculated from the expected value of the payout odds assigned by the odds processing unit 40 and an RTP rate of the baccarat game calculated from the corresponding standard odds is the second variation value. Preferably, the odds processing unit 40 assigns the plurality of odds values and the probabilities to be selected thereof in a manner of increasing the second variation value by a second designated value.

The first designated value and the second designated value described above may be automatically assigned by the game processing unit 10 or directly assigned by the operator. Preferably, the first designated value and the second designated value are positively correlated with a minimum allowable unit value of the bet. More specifically, when a plurality of minimum allowable unit values of the bet exist, a plurality of first designated values and second designated values having different values may be correspondingly set. A higher minimum allowable unit value corresponds to higher values of the first designated value and the second designated value. When the at least one player selects a higher minimum allowable unit value to place a bet, the player can obtain a higher first designated value and a higher second designated value. Accordingly, the at least one player can be attracted to place a high-value bet.

The second embodiment may also be implemented together with the plurality of value tables. Similarly, the plurality of odds values recorded in each of the value tables are greater than or equal to values of corresponding ones of the plurality of standard odds. Accordingly, a requirement that the values of the odds values are not reduced can be satisfied.

In the second embodiment, when the payout odds are assigned the odds values by the odds processing unit 40, the payout odds may be assigned according to the odds values recorded in Table 8, Table 9, and Table 10 and the corresponding probabilities to be selected.

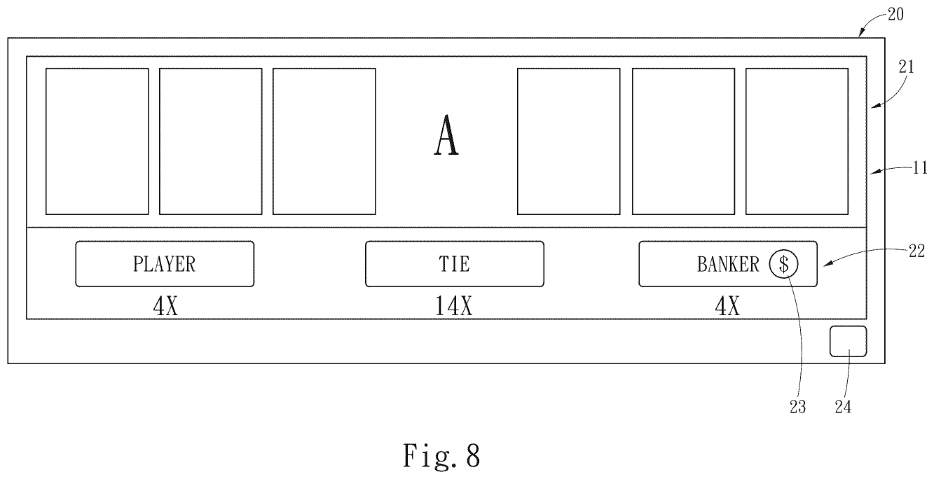

Referring to FIG. 8, in one embodiment, the generated random odds table is shown in Table 11.

TABLE 11

| | game result | | |
|---|---|---|---|
| betting option | player win | tie | banker win |
| betting on player | 5 times (4X) | 0 | 0 |
| betting on tie | 0 | 15 times (14X) | 0 |
| betting on banker | 0 | 0 | 5 times (4X) |

The payout odds for “player win” and “betting on player” are assigned as 5 times by the odds processing unit 40 (labeled as 4× in the drawing); the payout odds for “tie” and “betting on tie” are assigned as 15 times by the odds processing unit 40 (labeled as 14× in the drawing); and the payout odds for “banker win” and “betting on banker” are assigned as 5 times by the odds processing unit 40 (labeled as 4× in the drawing).

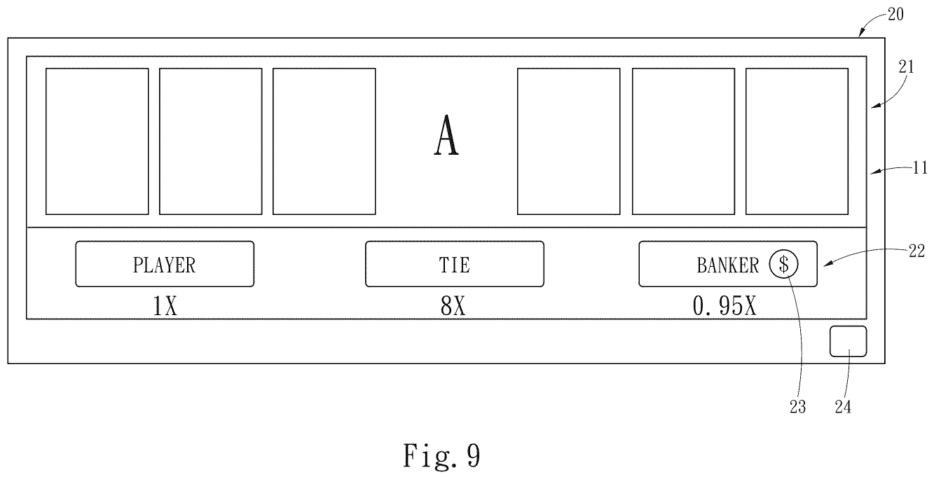

Referring to FIG. 9, in one embodiment, the generated random odds table is shown in Table 12.

TABLE 12

| | game result | | |
|---|---|---|---|
| betting option | player win | tie | banker win |
| betting on player | 2 times (1X) | 0 | 0 |
| betting on tie | 0 | 9 times (8X) | 0 |
| betting on banker | 0 | 0 | 1.95 times (0.95X) |

The payout odds for “player win” and “betting on player” are assigned as 2 times by the odds processing unit 40 (labeled as 1X in the drawing); the payout odds for “tie” and “betting on tie” are assigned as 9 times by the odds processing unit 40 (labeled as 8× in the drawing); and the payout odds for “banker win” and “betting on banker” are assigned as 1.95 times by the odds processing unit 40 (labeled as 0.95× in the drawing).

Apparently, in the second embodiment, the values assigned to the payout odds by the odds processing unit 40 are all greater than or equal to the standard odds.

In the second embodiment, because the values assigned to the payout odds by the odds processing unit 40 are all greater than or equal to the standard odds, the RTP rate of the baccarat game may exceed a value acceptable to the operator. Therefore, in the second embodiment, the payout unit 60 selects one of the random odds table and the standard odds table to pay out according to the game result generated in the at least one game round and the betting data.

In one embodiment, the random odds table is selected when the latest generated game result satisfies a designated condition, and the standard odds table is selected when the designated condition is not satisfied.

More specifically, when the game result satisfies the designated condition, for example, when the card values of the playing cards correspond to a natural (a total of 8 points or 9 points), or when no additional card is drawn, but not limited thereto, the payout odds recorded in the random odds table are used for payout. When the card values of the playing cards do not satisfy the designated condition, the standard odds recorded in the standard odds table are used for payout. Accordingly, when the game result corresponding to the bet placed by the player has not yet been generated (cards have not been revealed) or has not yet been completely generated (cards are partially revealed), the player can have anticipation during card reveal and can expect that the game result on which the player has placed the bet may satisfy the designated condition, thereby increasing player retention and entertainment of the game system of the present application.

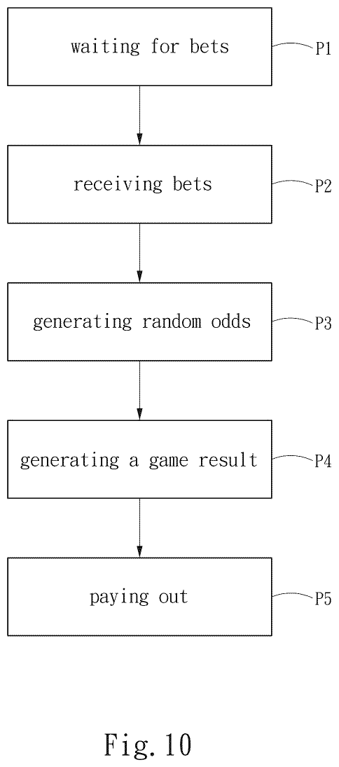

Referring to FIG. 10, FIG. 10 is an operation flow chart according to the second embodiment of the present application. The flow steps shown in the drawing are merely examples and are not limited thereto. In one embodiment, the game processing unit 10 performs steps P1 to P5.

Step P1: waiting for bets. The game processing unit 10 controls the user interface unit 20 to provide the plurality of betting options with the plurality of betting areas 22, so that the player bets on the plurality of betting options within a betting time.

Step P2: receiving bets. The game processing unit 10 controls the betting unit 30 to receive the signal corresponding to the bet 23 on the plurality of betting areas 22 to generate the betting data.

Step P3: generating random odds. The game processing unit 10 controls the odds processing unit 40 to generate the random odds table.

Step P4: generating a game result. The game processing unit 10 controls the game result generating unit 50 to randomly generate one of the game results according to the probability of occurrence. It is particularly noted that the order of step P3 and step P4 may be changed according to requirements, and is not limited to the above order.

Step P5: paying out. The game processing unit 10 controls the payout unit 60 to pay out according to each of the game results generated in the at least one game round, the betting data, and one of the random odds table and the standard odds table.

More specifically, each of the game results may be generated by the game processing unit 10. The betting data may be generated by the player betting on the betting options (“betting on player”, “betting on tie”, and “betting on banker”), and includes the bet amount of the bet 23 and the position information indicating which one of the plurality of betting areas 22 (betting options) the bet 23 is located on. After the payout unit 60 obtains the game results and the betting data, the payout unit 60 pays out according to one of the random odds table and the standard odds table. When the designated condition is satisfied, the payout unit 60 selects the random odds table to pay out. In one embodiment, payout is performed according to each of the random odds tables shown in Table 11 or Table 12. When the designated condition is not satisfied, the payout unit 60 selects the standard odds table to pay out. In one embodiment, payout is performed according to Table 1.

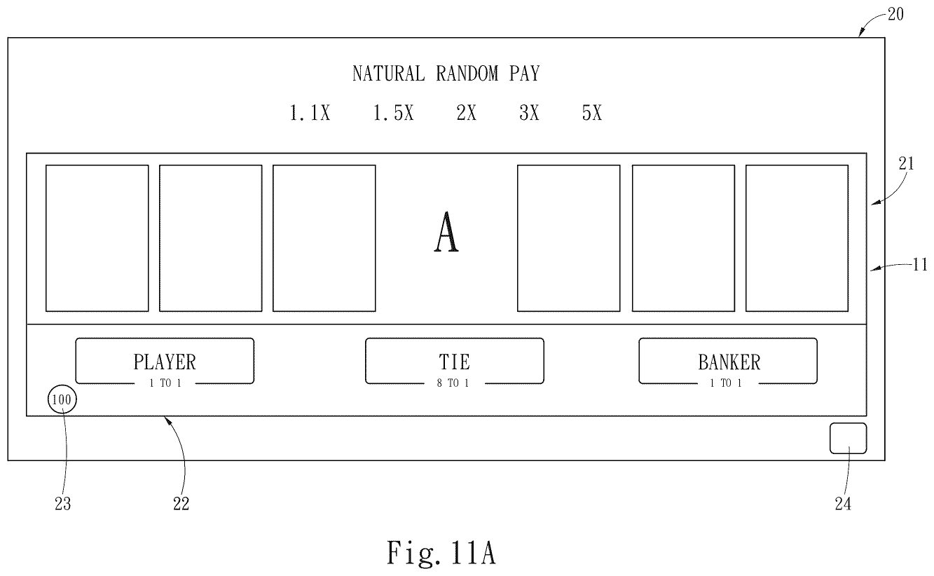

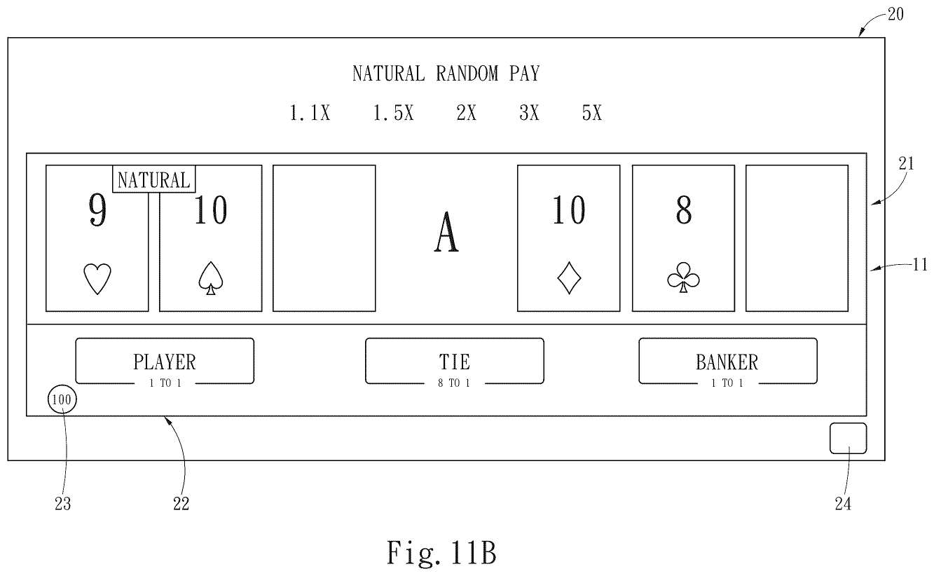

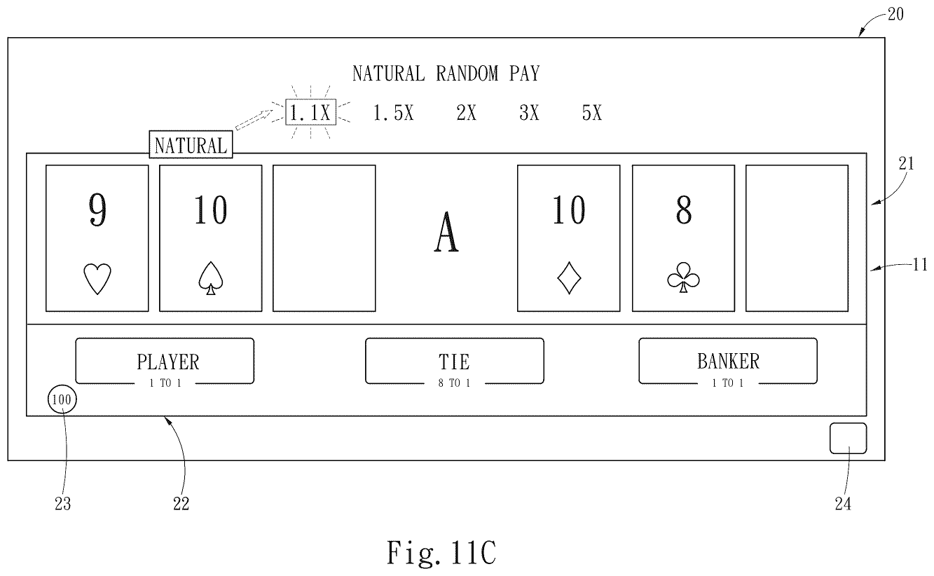

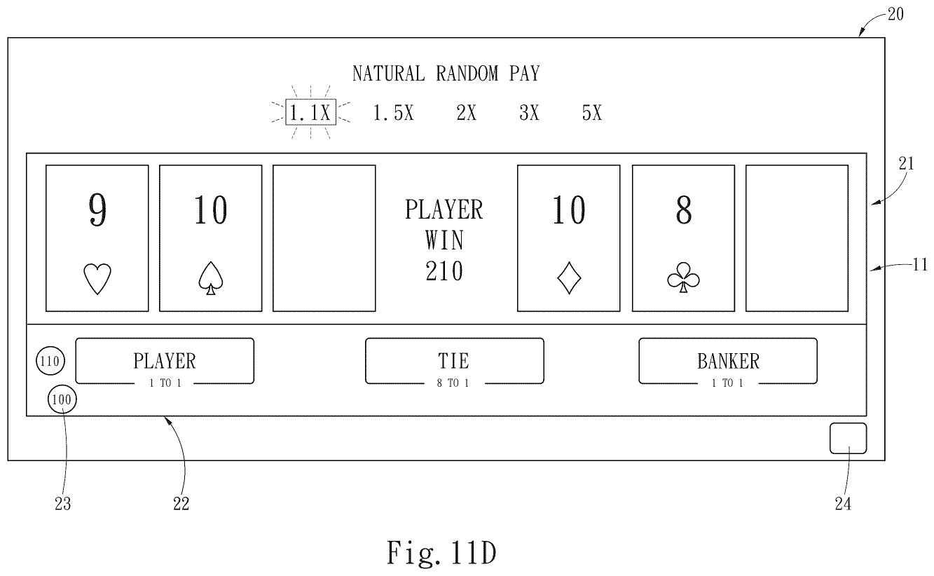

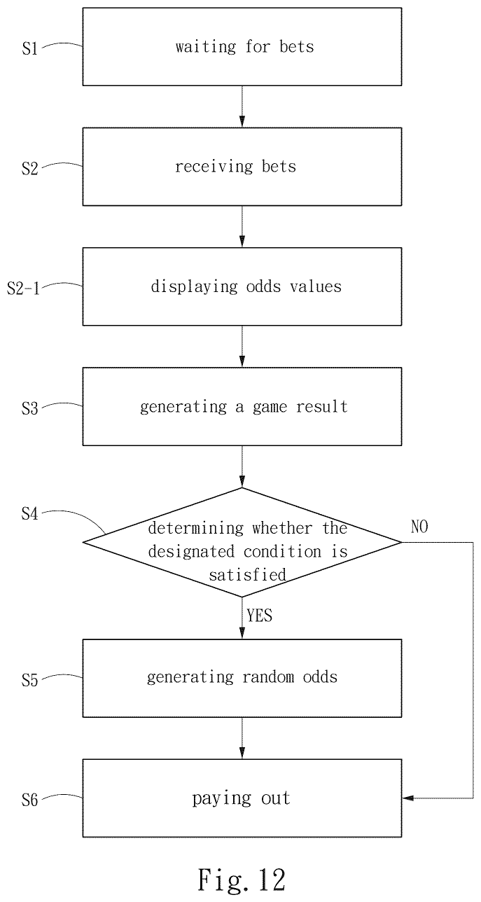

Referring to FIG. 1, FIGS. 11A to 11D, and FIG. 12, FIGS. 11A to 11D and FIG. 12 are exemplary game screens and an operation flow chart according to a third embodiment of the present application.

In the third embodiment, the plurality of odds values are assigned values greater than the corresponding standard odds. The third embodiment may also be implemented together with the plurality of value tables, and the plurality of odds values recorded in each of the value tables are greater than values of corresponding ones of the plurality of standard odds. Accordingly, a requirement that the values of the odds values only increase and do not decrease can be satisfied.

In one embodiment, the standard odds for the betting options of “betting on player”, “betting on tie”, or “betting on banker” are 1 to 1, 8 to 1, or 1 to 1, and are displayed on the corresponding plurality of betting areas 22.

In one embodiment, the value of the standard odds for “betting on player” is 1 to 1, namely 2 times including the bet amount to be returned, and the plurality of odds values (corresponding to the standard odds for “betting on player”) generated by the odds processing unit 40 may respectively be 2.1 times, 2.5 times, 3 times, 4 times, and 6 times (1.1×, 1.5×, 2×, 3×, and 5×).

Referring to FIG. 12, FIG. 12 is an operation flow chart according to the third embodiment of the present application. The flow steps shown in the drawing are merely examples and are not limited thereto. In one embodiment, the game processing unit 10 performs steps S1 to S6.

Step S1: waiting for bets. The game processing unit 10 controls the user interface unit 20 to provide the plurality of betting options with the plurality of betting areas 22, so that the player bets on the plurality of betting options within a betting time.

Step S2: receiving bets. The game processing unit 10 controls the betting unit 30 to receive the signal corresponding to the bet 23 on the plurality of betting areas 22 to generate the betting data.

In one embodiment, the game processing unit 10 further performs step S2-1: displaying odds values. Step S2-1 may be performed after step S2. After the betting data is generated, for example, chips are placed on the betting area 22 for “betting on player” to form the bet 23, and after the confirmation button 24 is pressed, the betting unit 30 generates the betting data. At this time, the game processing unit 10 controls the user interface unit 20 to display the plurality of odds values (1.1×, 1.5×, 2×, 3×, and 5×) on the game screen 21, as shown in FIG. 11A. In other embodiments, the odds values may also be displayed after a betting time ends (No more bet) or before the game result of the game round is generated, and the present application is not limited to a condition for displaying the odds values. In one embodiment, the plurality of odds values (1.1×, 1.5×, 2×, 3×, and 5×) are further marked with “NATURAL RANDOM PAY” for indicating that, when the card values of the playing cards form a natural, one of the plurality of odds values serves as the value of the payout odds.

Step S3: generating a game result. The game processing unit 10 controls the game result generating unit 50 to randomly generate one of the game results according to the probability of occurrence.

Step S4: determining whether the designated condition is satisfied. The game processing unit 10 determines whether the latest generated game result satisfies the designated condition. If yes, namely satisfied, step S5 is performed. If no, namely not satisfied, step S6 is performed.

In one embodiment, the designated condition is that the card values of the playing cards form a NATURAL and the player wins, but is not limited thereto. As shown in FIG. 11B, the player's hand is (9+10), and the banker's hand is (10+8). Since the player's hand is a natural and the player wins the game, the designated condition is satisfied.

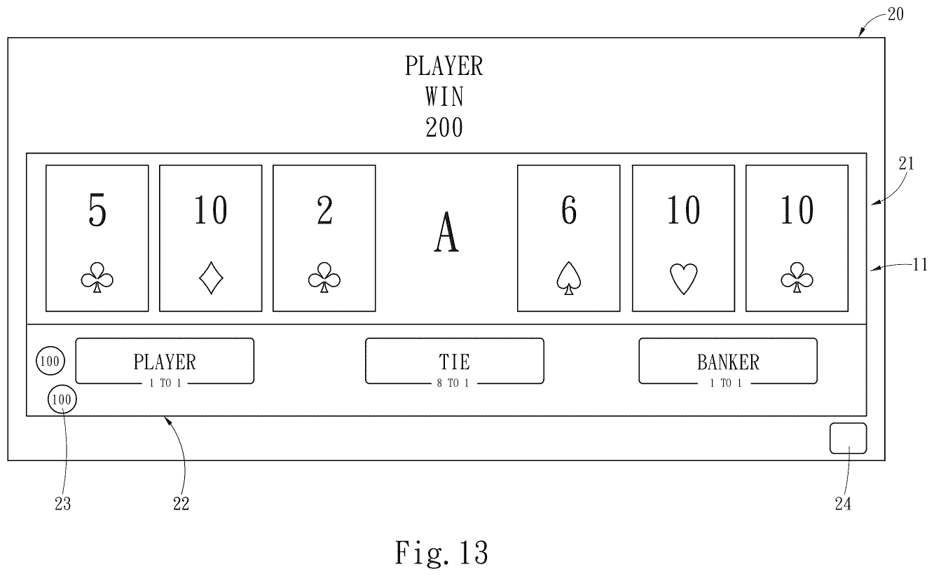

In another embodiment, as shown in FIG. 13, the player's hand is (5+10+2), and the banker's hand is (6+10+10). Although the player wins the game, the player does not have a natural, so the designated condition is not satisfied.

Step S5: generating random odds. The game processing unit 10 controls the odds processing unit 40 to generate the random odds table. It is particularly noted that step S5 may be performed only when the designated condition is satisfied. When the designated condition is not satisfied, step S5 is not performed in this embodiment, and step S6 is directly performed. Accordingly, the calculation load of the game processing unit 10 can be reduced.

In step S5, the game processing unit 10 controls the odds processing unit 40 to select according to the probabilities to be selected of the plurality of odds values, so that the plurality of odds values are assigned to each of the payout odds in a many-to-one manner. As shown in FIG. 11C, the odds value (1.1×) is selected as the payout odds for “player win”, thereby generating the random odds table. The game processing unit 10 controls the payout unit 60 to select the random odds table to pay out, and the payout is performed with an odds value of 2.1 times. That is, when a chip with a bet value of 100 is placed, a total chip value of 210 (100+110) can be won, as shown in FIG. 11D.

In one embodiment, the game processing unit 10 controls the user interface unit 20 to display the selected odds value among the plurality of odds values on the game screen 21 in a highlighted manner. Taking FIG. 11C as an example, the odds value (1.1×) selected for “player win” is displayed with radial light rays at an edge of the value. Alternatively, the selected odds value may be enlarged or changed to another brighter color, as long as the display manner differs from the original display manner, and the present application is not limited thereto. Accordingly, when the designated condition is satisfied, the player can expect to obtain one of the plurality of odds values with a higher value, and can clearly know, by the highlighted display, how many times the payout odds are randomly increased in the game round. Therefore, entertainment of the baccarat game system is maintained, thereby attracting the player to continue playing. In addition, after determining whether the designated condition is satisfied, the game processing unit 10 controls the odds processing unit 40 to select according to the probabilities to be selected of the plurality of odds values. This helps reduce the computing load of the game processing unit 10 and even the overall baccarat game system with random odds, and can further increase operating stability of the game system. For example, if only 30 game results satisfying the designated condition are generated in every 100 game rounds, selection processing by the game processing unit 10 can be reduced by 70 instances.

Step S6: paying out. The game processing unit 10 controls the payout unit 60 to pay out according to each of the game results generated in the at least one game round, the betting data, and one of the random odds table and the standard odds table.

More specifically, each of the game results may be generated by the game processing unit 10. The betting data may be generated by the player betting on the betting options (“betting on player”, “betting on tie”, and “betting on banker”). The betting data includes the bet amount of the bet 23 and the position information indicating which one of the plurality of betting areas 22 (betting options) the bet 23 is located on. After the payout unit 60 obtains the game results and the betting data, the payout unit 60 pays out according to one of the random odds table and the standard odds table. When the designated condition is satisfied, the payout unit 60 selects the random odds table to pay out. When the designated condition is not satisfied, the payout unit 60 selects the standard odds table to pay out. For example, payout is performed with the odds value of 1 to 1 (2 times). That is, when a chip with a bet value of 100 is placed, a total chip value of 200 (100+100) can be won, as shown in FIG. 13.

In summary, the advantages of the present application at least include the following:

1. The odds processing unit provides variable payout odds, so that the player has an opportunity to obtain odds exceeding an expected value within a short game time, thereby enhancing player engagement.

2. Under the premise that the RTP rate is limited to a minimum variation or only increased by a designated value, by designing a portion of the plurality of odds values lower than values of corresponding ones of the plurality of standard odds, a possible value range of the plurality of odds values can be increased, and volatility of the game provided by the baccarat game system of the present application is increased, thereby enhancing player engagement.

3. When the odds processing unit provides variable payout odds, the RTP rate is limited to a minimum variation or only increased by a designated value, and therefore the interest of the operator can be ensured when the player plays the game over the long term.

4. By displaying the plurality of odds values in advance on the game screen, the player knows that, when the designated condition is satisfied, one of the plurality of odds values may serve as the value of the payout odds, which helps maintain motivation of the player to play the game.

What is claimed is:

1. A baccarat game system with random odds, providing a baccarat game for at least one game round, the baccarat game having a plurality of game results and a standard odds table, each of the game results having a probability of occurrence in the at least one game round, and the standard odds table being assigned a plurality of standard odds, the baccarat game system comprising:
a user interface unit, configured to display a game screen of the at least one game round and a plurality of betting areas, the plurality of betting areas respectively corresponding to a plurality of betting options, so as to allow at least one player to bet on at least one of the plurality of betting options;
a betting unit, configured to receive a signal corresponding to a bet placed on the plurality of betting areas in the at least one game round to generate betting data;
an odds processing unit, configured to generate a random odds table, the random odds table having a plurality of payout odds respectively associated with one of the plurality of game results and one of the plurality of betting options;
wherein when any of the betting options and any of the game results, which are associated with one of the plurality of payout odds, do not correspond to each other, that one of the payout odds is assigned a value of 0 by the odds processing unit;
wherein when any of the betting options and any of the game results, which are associated with one of the plurality of payout odds, do correspond to each other, the odds processing unit generates one of a plurality of odds values correspondingly for that one of the payout odds, wherein each of the plurality of payout odds and the corresponding one of the plurality of standard odds are associated with the same one of the betting options and the same one of the game results;
wherein the plurality of odds values corresponding to each of the payout odds respectively have probabilities to be selected, and the odds processing unit selects according to the probabilities to be selected of the plurality of odds values, so that the plurality of odds values are assigned to each of the payout odds in a many-to-one manner;
wherein a portion of the plurality of odds values are lower than values of the corresponding ones of the plurality of standard odds;
a game result generating unit, configured to randomly generate one of the plurality of game results in the at least one game round;
a payout unit, configured to pay out according to each of the game results generated in the at least one game round, the betting data, and the random odds table; and
a game processing unit, connected to the user interface unit, the betting unit, the odds processing unit, the game result generating unit, and the payout unit, wherein the odds processing unit is controlled by the game processing unit to generate the random odds table.

2. The baccarat game system of claim 1, wherein a difference between an expected value of each of the plurality of payout odds assigned by the odds processing unit and an expected value of the corresponding standard odds is a first variation value, and the plurality of odds values satisfy a requirement that the first variation value is minimized.

3. The baccarat game system of claim 2, wherein the odds processing unit obtains at least one of an upper limit, a lower limit, and a quantity of the plurality of odds values, so that the odds processing unit generates the plurality of odds values according thereto.

4. The baccarat game system of claim 1, wherein a difference between an RTP rate of the baccarat game calculated from expected values of the plurality of payout odds assigned by the odds processing unit and that calculated from corresponding ones of the standard odds is a second variation value, and the plurality of odds values satisfy a requirement that the second variation value is minimized.

5. The baccarat game system of claim 4, wherein the odds processing unit obtains at least one of an upper limit, a lower limit, and a quantity of the plurality of odds values, so that the odds processing unit generates the plurality of odds values according thereto.

6. The baccarat game system of claim 1, wherein the baccarat game system further comprises a memory unit configured to store a plurality of value tables, the plurality of value tables respectively recording different sets of the plurality of odds values, wherein when the plurality of payout odds are assigned by the odds processing unit, after the game processing unit receives an activation signal, the game processing unit activates one of the plurality of value tables and controls the odds processing unit to assign the plurality of odds values recorded in any of the value tables that are activated to each of the plurality of payout odds in a many-to-one manner, wherein a portion of the plurality of odds values recorded in each of the value tables are lower than the values of corresponding ones of the standard odds.

7. The baccarat game system of claim 6, wherein a difference between an expected value of each of the plurality of payout odds assigned by the odds processing unit and the expected value of the corresponding one of the standard odds is a first variation value, and the plurality of odds values satisfy a requirement that the first variation value is minimized.

8. The baccarat game system of claim 6, wherein a difference between an RTP rate of the baccarat game calculated from expected values of the payout odds assigned by the odds processing unit and that calculated from corresponding ones of the standard odds is a second variation value, and the plurality of odds values satisfy a requirement that the second variation value is minimized.

9. A baccarat game system with random odds, providing a baccarat game for at least one game round, the baccarat game having a plurality of game results and a standard odds table, each of the game results having a probability of occurrence in the at least one game round, and the standard odds table being assigned a plurality of standard odds, the baccarat game system comprising:
a user interface unit, configured to display a game screen and a plurality of betting areas for the at least one game round, the plurality of betting areas respectively corresponding to a plurality of betting options, so as to allow at least one player to bet on at least one of the plurality of betting options;
a betting unit, configured to receive a signal corresponding to a bet placed on the plurality of betting areas in the at least one game round to generate betting data;
an odds processing unit, configured to generate a random odds table, the random odds table having a plurality of payout odds, the plurality of payout odds being respectively associated with one of the game results and one of the betting options;
wherein when any of the betting options and any of the game results, which are associated with one of the plurality of payout odds, do not correspond to each other, that one of the payout odds is assigned a value of 0 by the odds processing unit;
wherein when any of the betting options and any of the game results, which are associated with one of the plurality of payout odds, do correspond to each other, the odds processing unit generates one of a plurality of odds values correspondingly for that one of the payout odds, wherein each of the plurality of payout odds and the corresponding one of the plurality of standard odds are associated with the same one of the betting options and the same one of the game results;
wherein the plurality of odds values corresponding to each of the plurality of payout odds respectively have probabilities to be selected, and the odds processing unit selects according to the probabilities to be selected of the plurality of odds values, so that the plurality of odds values are assigned to each of the plurality of payout odds in a many-to-one manner;
wherein the plurality of odds values are greater than or equal to values of the corresponding ones of the plurality of standard odds;
a game result generating unit, configured to randomly generate one of the plurality of game results in the at least one game round;
a payout unit, configured to select one of the random odds table and the standard odds table to pay out according to each of the game results generated in the at least one game round and the betting data; and
a game processing unit, connected to the user interface unit, the betting unit, the odds processing unit, the game result generating unit, and the payout unit, wherein the odds processing unit is controlled by the game processing unit to generate the random odds table.

10. The baccarat game system of claim 9, wherein a difference between an expected value of each of the plurality of payout odds assigned by the odds processing unit and an expected value of the corresponding standard odds is a first variation value, and the plurality of odds values satisfy a requirement that the first variation value is minimized.

11. The baccarat game system of claim 10, wherein the odds processing unit obtains at least one of an upper limit, a lower limit, and a quantity of the plurality of odds values, so that the odds processing unit generates the plurality of odds values according thereto.

12. The baccarat game system of claim 10, wherein a first designated value is positively correlated with a minimum allowable unit value of the bet.

13. The baccarat game system of claim 9, wherein a difference between an RTP rate of the baccarat game calculated from expected values of the plurality of payout odds assigned by the odds processing unit and that calculated from corresponding ones of the standard odds is a second variation value, and the plurality of odds values satisfy a requirement that the second variation value is minimized.

14. The baccarat game system of claim 13, wherein the odds processing unit obtains at least one of an upper limit, a lower limit, and a quantity of the plurality of odds values, so that the odds processing unit generates the plurality of odds values according thereto.

15. The baccarat game system of claim 13, wherein a second designated value is positively correlated with a minimum allowable unit value of the bet.

16. The baccarat game system of claim 9, wherein the baccarat game system further comprises a memory unit configured to store a plurality of value tables, the plurality of value tables respectively recording different sets of the plurality of odds values; wherein, when the plurality of payout odds are assigned by the odds processing unit, after the game processing unit receives an activation signal, the game processing unit activates one of the plurality of value tables and controls the odds processing unit to assign the plurality of odds values recorded in any of the value tables that are activated to each of the plurality of payout odds in a many-to-one manner, wherein the plurality of odds values recorded in each of the value tables are greater than or equal to values of corresponding ones of the plurality of standard odds.

17. The baccarat game system of claim 16, wherein a difference between an expected value of each of the plurality of payout odds assigned by the odds processing unit and an expected value of the corresponding standard odds is a first variation value, and the plurality of odds values satisfy a requirement that the first variation value is minimized.

18. The baccarat game system of claim 17, wherein a first designated value is positively correlated with a minimum allowable unit value of the bet.

19. The baccarat game system of claim 16, wherein a difference between an RTP rate of the baccarat game calculated from expected values of the plurality of payout odds assigned by the odds processing unit and that calculated from corresponding ones of the standard odds is a second variation value, and the plurality of odds values satisfy a requirement that the second variation value is minimized.

20. The baccarat game system of claim 19, wherein a second designated value is positively correlated with a minimum allowable unit value of the bet.

21. The baccarat game system of claim 9, wherein when the latest generated game result satisfies a designated condition, the game processing unit controls the odds processing unit to select according to the probabilities to be selected of the plurality of odds values, so that the plurality of odds values are assigned to each of the plurality of payout odds in a many-to-one manner, and the game processing unit controls the payout unit to select the random odds table to pay out.

22. The baccarat game system of claim 21, wherein before the game processing unit selects, the game processing unit controls the user interface unit to display the plurality of odds values on the game screen.

23. The baccarat game system of claim 21, wherein the plurality of odds values are greater than values of corresponding ones of the plurality of standard odds.
